(19) United States
(12) Patent Application Publication
(10) Pub. No.: US 2003/0148248 A1
(43) Pub. Date: Aug. 7, 2003

(54) Action fractions

(76) Inventor: Malcolm W. Kirby, Santa Cruz, CA (US)

Correspondence Address: Malcolm W. Kirby, 831 Paradise Park, Santa Cruz, CA, 95060, US

(21) Appl. No.: 10/336,184

(22) Filed: Jan. 6, 2003

Related U.S. Application Data
(60) Provisional application No. 60/347,022, filed on Jan. 10, 2002.

(51) Int. Cl. G09B 11/00

(52) U.S. Cl. 434/81

(57) ABSTRACT

A set of blocks are used as manipulatives to enhance learning of fractional numbers. Block lengths correspond to fractional numbers. The cross section of the blocks is polygonal. Graduations which are scored or embossed on the block faces correspond to lengths of shorter blocks. The combined lengths of a subset of blocks have a one-to-one correspondence with points on a mathematical “number line”, hence block length equates only to size. It follows that manipulations involve changes in size without being linked to changes in shape. This contrasts with two dimensional objects where fractional parts differ in both size and shape. Four games are introduced. Play involves exchanging one subset of blocks for another, where the number of blocks in the final subset is given.

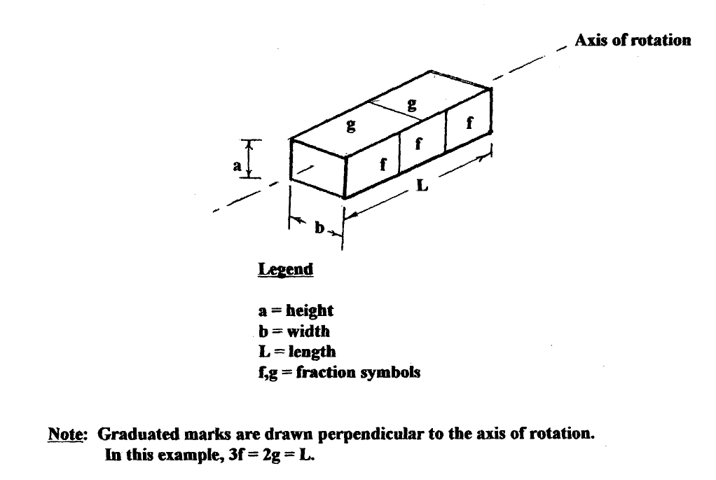

### CROSS REFERENCE TO RELATED APPLICATIONS

Not applicable.

### STATEMENT REGARDING FEDERALLY SPONSORED RESEARCH OR DEVELOPMENT

Not applicable

### REFERENCE TO SEQUENCE LISTING, TABLE, COMPUTER PROGRAM

Not applicable.

### BACKGROUND OF THE INVENTION

1. The field of endeavor is Toys, educational (mathematics),. The invention pertains to physical objects, blocks, used as manipulatives. The purpose of the invention is the learning of fractional numbers by means of playing games using the blocks.

2. Problems involved in the prior art. Teachers use blackboards, pencils, paper, books with drawings and exercises, supplemented by manipulatives. In almost all cases the drawings and/or manipulatives are two dimensional objects such as circles, squares, and triangles. The shapes of the fractional parts are not constant; but differ according to the size of the part. Hence, a child is faced with two contending ideas: shape and size And these two ideas are inextricably connected. Since ordinary arithmetic deals with numbers, not shapes, ordinary arithmetical operations do not involve shape or position. A number line is a theoretical construct of one dimension, namely size. And both ordinary numbers and fractional numbers are points on the number line. Since the blocks correspond to such points, they are, therefore, a representation of fractional numbers in physical form. Only the length of a block is important whereas the thickness is incidental.

3. Children often struggle to reconcile the difference between arithmetic results and physical results. For example, actually cutting a block ½ unit long into 2 equal pieces gives two blocks of ¼ unit. But the,arithmetic result of dividing ½ by 2 is only one quarter. So, the blocks provide a physical counterpart to arithmetic operations, and help students overcome the arbitrariness of conventional arithmetic rules.

4. The idea of reducing a fractional number to its “simplest” form is not usually motivated by any good reason in classrooms or textbooks. But the game of “One Block” provides exactly this kind of motivation. For example, the arithmetic values of 2/4 and ½ are the same. But, in this game a single block ½ unit long is preferred to two blocks ¼ unit long., A single block is “simpler” than two blocks. Hence, this game provides a way to rationalize a traditional, arbitrary rule of arithmetic.

### BRIEF SUMMARY OF THE INVENTION

1. The invention pertains to blocks of varying lengths, according to fractional lengths of a unit block. The blocks may be arranged end-for-end, and substituted, a few for many, or many for a few, according to the rules of defined games. The purpose of such exchanges iis the learning of mathematical concepts involving fractional numbers, such as equivalence, substitution, commutation, as well as the operations of division, multiplication, addition and subtraction.

2. As an example, consider two fractional blocks, one being ⅓ unit long and the other being ⅙ unit long. They can be rotated to reveal faces on which appear equivalent fractions of 4/12 and 2/12, respectively. Placed end-for-end, their combined length equals 6/12.

3. Now consider a third block, 6/12 units long, which may be substituted for these two blocks. When the third block is rotated, another face marked ½ unit is made to appear. These are movements in a defined game, and they correspond exactly to the traditional mathematical tasks of adding unlike fractions, by finding equivalents with common denominators, substituting, and “reducing the result to its simplest form”. This is an example of the first of four games described herein, wherein a subset of blocks is substituted for another subset of equivalent length.

### BRIEF DESCRIPTION OF THE DRAWING

1. The attached figure shows an example of a block, in isometric form. Two faces are shown, the two other faces are similar except for the graduations. In this drawing, graduation marks are scored, and the fractional number symbols are denoted as “f” and “g”, and the block length is denoted “L”. This is a special case where 3f=2g=L

### DETAILED DESCRIPTION OF THE INVENTION

1. The educational toy comprises a set of blocks, of varying lengths. All blocks have a uniform cross section in the form of a regular polygon. The surface of each block comprises two ends and as many faces as there are sides of the polygon. The number of sides may be as few as three or as many as twelve. The Figure shows an example of a block with rectangular cross section.

2. A fractional number means a number expressed according to the following rule: Let K and N be members of the finite numerical series comprising positive integers (e.g. 1,2,3,4,5, . . . ,.etc). The arithmetic expression K/N (i.e. K divided by N) may be a proper fraction (K less than N) or an improper fraction (K larger than N). Then, the lengths of the blocks in a set is determined by choices of K/N.

3. Symbols denoting these fractional numbers may be chosen from any written language.

4. Every face has graduated marks, either lines, grooves, or raised embossments. Graduated means uniformly divided according to a scale beginning at the end of the block. The distance between adjacent graduation marks represents a fractional length, as described above.

5. Each such fractional length is denoted by a symbol and is printed, engraved or embossed on each face between adjacent graduation marks. Graduations correspond to lengths of smaller blocks in the set.

6. The composition of the blocks may be wood, metal, plastic, ceramic or other similar material, and the blocks may be solid or hollow, of any color, with smooth or mildly textured surface. Blocks may be shaped by cutting, casting, extrusion, forging or bending & joining sheet stock. Symbols and scoring may be accomplished as an integral part of making the block or may be separately affixed as labels or by printing or drawing.

7. The purposes of the blocks are amusement and learning by manipulating the blocks. Short blocks, placed end-to-end form a group, and verifying that their combined length equals the length of one or more longer blocks, corresponds to the arithmetic operation of adding or multiplying fractional numbers. Whereas, removing blocks from such a group corresponds to subtraction or division of fractional numbers. And, replacing such a group by a single block of equal length corresponds to the arithmetic operation of reducing the result to its simplest form, often called “simplifying” or “reducing” a fractional number.

8. The shortest block has only one equivalent, namely itself. But all the other blocks have equivalents which may be found by rotating the block about an axis parallel to its faces, in either direction. This reveals alternative graduations with fractional symbols, where the sum of the fractional numbers on any face equals the sum of the fractional numbers on any other face. By this means, alternative fractional equivalents may be demonstrated, and common denominators may be found by rotating a block. This manipulation is an alternative to the counting of several individual blocks.

9. The invention includes four games denoted: “One Block”, “Two Blocks”, “Three Blocks”, and “Four Blocks” with similar rules. Blocks are arranged end-for-end so that their combined length can be determined. Then, given the length of a specified subset of the blocks, the object of the game is to find M blocks of equal length; where M=1, 2, 3, or 4, respectively, according to which of the four games is being played. Solutions illustrate mathematical concepts such as adding unlike fractions, and dividing or multiplying fractions by whole numbers, and “reducing the result to its simplest form”. Counting is the only skill needed

10. Such play has several advantages. The activities enable a child to obtain tactile sensations of linear fractional length. Together with counting of blocks and/or graduations, they enable the child to discover such mathematical concepts as equivalent fractional numbers, common denominators, and arithmetic operations involving fractional numbers.

11. The difference between large and small blocks is simply length. This exactly corresponds to the idea that fractional numbers represent size. The blocks are, therefore, physical representations of portions of the mathematical “number line”, so they represent fractional numbers in the simplest possible way, namely, length.

12. These advantages may be appreciated by contrasting the blocks with other educational toys which consist or two dimensional objects, and/or pictures of such objects, where differences in size necessarily involve differences in shape, and/or position. Learning fractions by such means requires coping with at least two separate, dissimilar ideas instead of only one idea, namely size.

13. The advantages of the blocks are especially important to individuals who are handicapped by impaired vision, hearing or motor skills. Such persons have a heightened sense of touch, and the blocks can be adapted to meet such special needs, e.g. Braille for the blind.

1. I make the following claim: The idea of blocks having graduations in the form of equivalent fractional numbers on block faces, where such graduations match the lengths of smaller blocks in a set is unique, in that equivalent fractional numbers may be discerned in two ways: (1) by counting individual blocks or (2) by counting graduations on blocks. The mere rotation of a block reveals equivalent fractions, thereby obviating the necessity of calculating to find common denominators. Most importantly, since all equivalents have a physical form, the proof of equivalence is discernible by touching the scored or embossed graduation marks on the faces. This feature opens the way for learning by children.
I also make the following claim: That lengths of individual blocks or subsets of blocks, arranged end-for-end, correspond to points on a mathematical number line; hence, these arrangements do not introduce any significant changes of shape. This feature enhances children's learning because they are concerned only with length instead of both length and shape.
I also make the following claim: The invention of four games, denoted: “One Block”, “Two Blocks”, “Three Blocks”, and “Four Blocks” is unique. The rules are similar for each game. For any specified subset of the blocks, find M block(s) with a combined length that equals the length of the specified subset, where M=1, 2, 3, or 4, respectively, for the games denoted above. The manipulations correspond to mathematical concepts of adding or subtracting unlike fractions, and dividing or multiplying fractions by whole numbers, and, in the case of M=1, of “reducing the result to its simplest form”.
